(19) United States
(12) Patent Application Publication
(10) Pub. No.: US 2002/0091619 A1
(43) Pub. Date: Jul. 11, 2002

(54) On-line purchase supplier web site managing system

(76) Inventor: Chen Shi Yang, San Jose, CA (US)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/810,210

(22) Filed: Mar. 19, 2001

(30) Foreign Application Priority Data
Jan. 5, 2001 (TW) 090 100414

(51) Int. Cl. G06F 17/60

(52) U.S. Cl. 705/37

(57) ABSTRACT

On-line purchase supplier web site managing system. An enterprise web site is built in a servo main frame, enabling an enterprise owner to through internet make on-line purchase trade with suppliers. The enterprise web site includes a supplier web site managing system by which suppliers can directly set up basic data of their companies and products in the enterprise web site. The supplier web site managing system includes a supplier data managing system, a supplier department managing system, a supplier employee managing system, a supplier product managing system and a price offer/negotiation list maintaining/managing system. The present invention provides a trade web site which can easily combine information of the enterprise and suppliers and make on-line purchase.

### BACKGROUND OF THE INVENTION

The present invention is related to an on-line purchase supplier web site managing system, and more particularly to a trade web site managing system which through internet makes on-line purchase. By means of this web site managing system, the information of suppliers are combined with the purchase system of an enterprise owner.

Generally, in an enterprise, the purchase is executed by purchasers. After personnel of the enterprise submit a requirement, the purchasers query the price, compare the price and negotiate the price and then give an order to the supplier. Such purchase procedure is quite time-consuming and has many shortcomings. For example, the price query/negotiation procedure is not so open and depends on the honesty of the purchasers. In the case that a purchaser resigns and a new one takes over the purchase work, it will be hard for the new purchaser to learn know-how of the previous one. Moreover, in the case that it is difficult to gain complete information of the suppliers and it is hard to purchase all the necessary materials and parts at one time, it will be necessary to give orders to respective suppliers. As a result, the purchase time will be prolonged.

In the case that the suppliers themselves develop and build private web sites to run electronic business, the suppliers will have to invest on software and hardware (including servo main frame, private line, network equipment, application software, etc.) which are quite expensive. In addition, relevant web site servicemen and computer engineers are necessary to readily modify the contents of the products and data of employees and departments. This leads to high investment which can be hardly afforded by small or middle scale businesses. Therefore, in the case that the trade web site of an enterprise owner provides a combination service, the small or middle scale businesses will be free from such high expense.

### SUMMARY OF THE INVENTION

It is therefore a primary object of the present invention to provide an on-line purchase supplier web site managing system which enables an enterprise owner to easily manage basic data and product data of suppliers so that the suppliers can save the cost and labor for setting up and maintaining electronic business web site.

It is a further object of the present invention to provide the above on-line purchase supplier web site managing system which is able to combine the resources of all the suppliers so that the enterprise can simplify purchase procedure and save personnel and management cost.

It is still a further object of the present invention to provide the above on-line purchase supplier web site managing system which by way of web site combines internal resource of the enterprise with the resource of upstream suppliers to achieve the object of management of purchase, sale and storage.

The present invention can be best understood through the following description and accompanying drawings wherein:

### BRIEF DESCRIPTION OF THE DRAWINGS

FIG. 1 is a diagram showing the structure of the on-line purchase trade web site of the present invention;

FIG. 2 is a diagram showing the structure of the supplier web site managing system of the present invention;

FIG. 3 is a flow chart of the supplier data managing system of the present invention;

FIG. 4 is a flow chart of the supplier department managing system of the present invention;

FIG. 5 is a flow chart of the supplier employee managing system of the present invention;

FIG. 6 is a flow chart of the supplier product managing system of the present invention; and

FIG. 7 is a flow chart of the price offer/negotiation list maintaining/managing system of the present invention.

### DETAILED DESCRIPTION OF THE PREFERRED EMBODIMENT

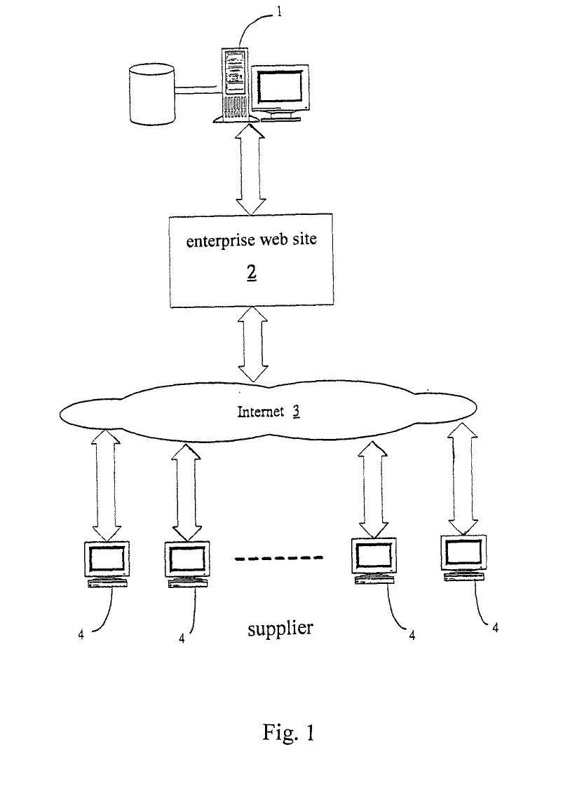

Please refer to FIG. 1. Through internet, the present invention establishes a trade web site for making on-line purchase trade. According to the present invention, an enterprise web site 2 is built in an inside servo main frame 1 of the enterprise. The enterprise web site 2 enables an enterprise owner to through internet 3 make purchase trade with one or more than one supplier 4. Each supplier 4 also can through a computer connect with the internet 3 and gain access to the enterprise web site 2 to make business trade with the enterprise owner. The applicant's Taiwanese Patent Application No. 89127193, filed on Dec. 19, 2000, discloses a trading method and system using a computer to make on-line purchase. The web page formality used by the enterprise web site of the present invention is written in HTML, JAVA SCRIPT, SQL, JSP, etc., including distributive construction, article guide technique, interactively used interface, etc. The hardware used in the present invention for connecting with the internet include computer, modem, xDSL modem, cable modem, modem private line, etc. The software include web page viewer, mail transceiver, etc.

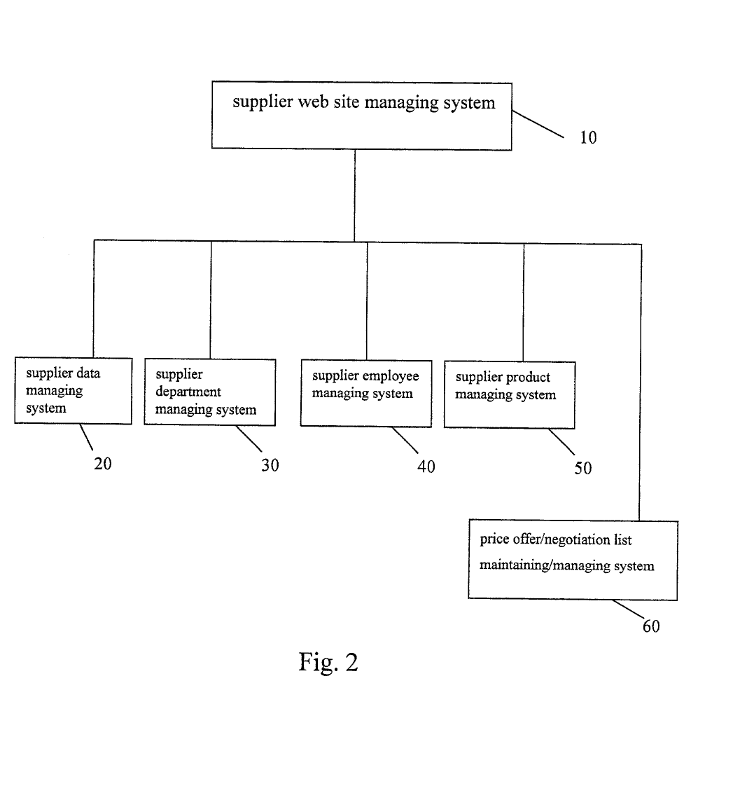

FIG. 2 shows the main structure of the supplier web site managing system for making on-line purchase of the present invention. An enterprise web site 2 is built in an inside servo main frame 1 of the enterprise. The enterprise web site 2 mainly includes a supplier web site managing system 10 by which suppliers set up basic data of their companies and their products on the enterprise web site 2. Accordingly, the resources of all suppliers can be combined to make on-line purchase and query and negotiation of price. Therefore, the suppliers are unnecessary to set up their own electronic business trade web site.

After the suppliers set up and maintain basic data of their companies and products, the enterprise owner can use these data to go for purchase trade without re-inputting data. Each time the suppliers gain access to the enterprise web site 2, they must first input supplier codes, user codes and passwords. Only after identified, the suppliers can enter the enterprise web site 2 for trade. The supplier web site managing system 10 includes a supplier data managing system 20, a supplier department managing system 30, a supplier employee managing system 40, a supplier product managing system 50 and a price offer/negotiation list maintaining/managing system 60. The supplier data managing system 20 mainly serves to set up and maintain basic data of the suppliers' companies, including trade manner data, etc. The supplier department managing system 30 mainly serves to set up and maintain the department data of the suppliers. The supplier employee managing system 40 mainly serves to set up and maintain the employee data of the suppliers. The supplier product managing system 50 mainly serves to set up and maintain the data of the products sold by the suppliers. The price offer/negotiation list maintaining/managing system 60 mainly serves to maintain and manage the price offer/negotiation lists of the suppliers to the enterprise owner.

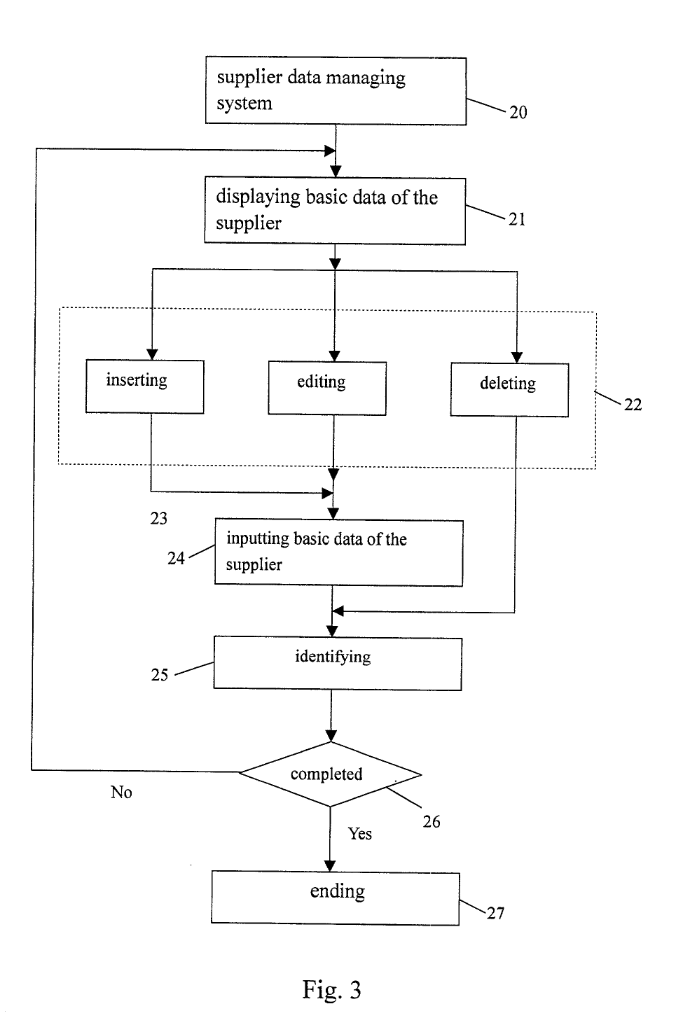

FIG. 3 is a managing flow chart of supplier data according to the present invention. The supplier data managing system 20 of the present invention enables the suppliers gaining access to the enterprise web site 2 to insert, edit and delete company basic data in preset field. The set up or maintained data are all stored a database of the servo main frame 1. The execution steps of the supplier data managing system 20 include:

(a) displaying basic data of the supplier in the database 21;

(b) inserting, editing or deleting basic data of the supplier 22, in case of editing, jumping to step (d), in case of deletion of field, jumping to step (e);

(c) inserting supplier data, the present invention automatically giving a supplier code 23;

(d) inputting basic data of the supplier 24;

(e) identifying 25, after identified, the basic data of the supplier being stored in the database;

(f) if insertion, edition or deletion is completed 26, if not, steps (a) to (f) being repeated; and

(g) insertion, edition or deletion of basic data of the supplier is completed 27.

The supplier data managing system 20 includes preset fields for the supplier's basic data:

a company name field including field of Chinese and English names and abbreviations or short names, etc.;

a company address field including field of country, state/province, city, zip code and detailed address, etc.;

a telephone/facsimile field including field of telephone number, cellular phone number and facsimile number, etc.;

a company web address field;

a company data field including field of capital, number of employees, classification of business, etc.;

a president field including field of name, extension number, E-mail box, etc. of the president;

a company contact man field including field of name, position, extension number, E-mail box, etc. of the contact man;

an invoice data field including field of invoice classification, invoice title, invoice address, etc.;

a shipping manner field including field of shipping condition, shipping description and delivery date, etc.;

a trade manner field including field of trade manner, trade condition description, trade monetary kind, pay way, pay condition description, pay date, tax rate, etc.;

a registration date field;

a use period field including on-line date and off-line date; and

a bank data field including field of bank name, account classification, account name, account number, bank address, telephone and facsimile numbers of bank contact man, etc.

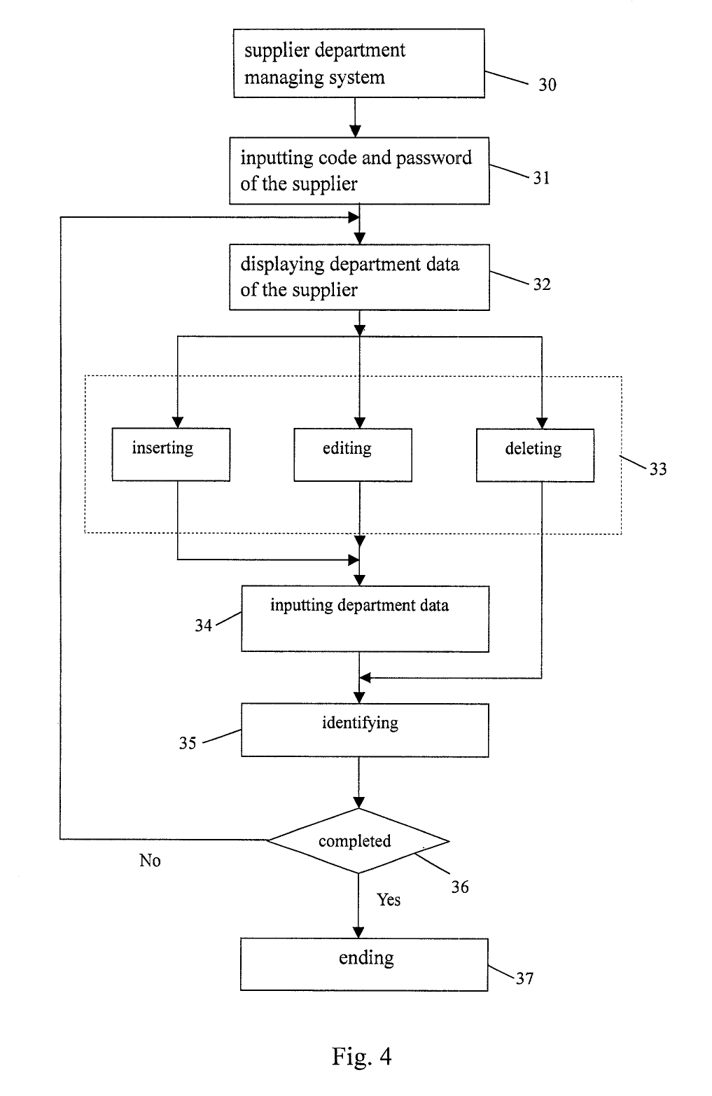

FIG. 4 is a flow chart of management of supplier department according to the present invention. The supplier department managing system 30 of the present invention enables the suppliers to use the enterprise web site 2 to manage the department data of their own companies. The suppliers can manage these departments according to different products (such as official machine department or computer sale department) or different business properties (such as business department or accounting department). The execution steps of the supplier department managing system 30 include:

(a) inputting code and password of the supplier 31;

(b) displaying department data of the supplier in the database 32;

(c) inserting, editing or deleting a department 33, in case of deletion, jumping to step (e), otherwise, next step being executed;

(d) inputting department data 34, including field of department name, department code, department description, etc.;

(e) identifying 35, after identified, the department data being stored in the database;

(f) if insertion, edition or deletion of department data is completed 36, if not, steps (b) to (f) being repeated; and

(g) insertion, edition or deletion of department data of the supplier is completed 37.

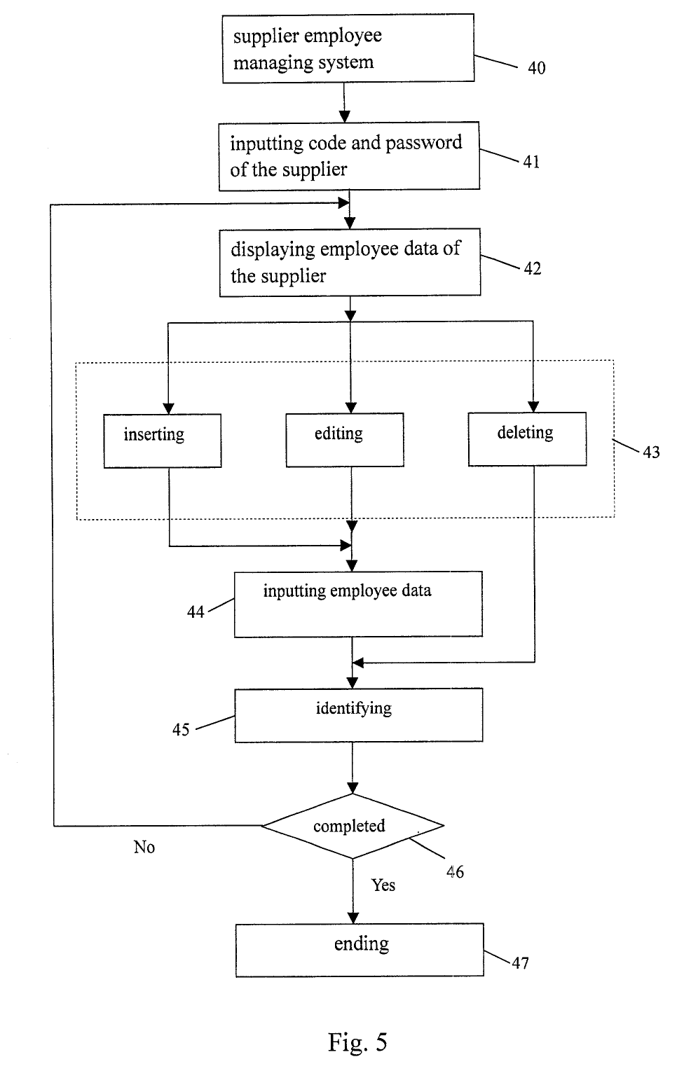

FIG. 5 is a flow chart of management of supplier employees according to the present invention. The supplier employee managing system 40 of the present invention enables the suppliers to manage data of those employees who can gain access to the enterprise web site 2 for trade. The execution steps of the supplier employee managing system 40 include:

(a) inputting code and password of the supplier 41;

(b) displaying employee data of the supplier in the database 42;

(c) inserting, editing or deleting employee data 43, in case of deletion, jumping to step (e), otherwise, next step being executed;

(d) inputting employee data 44, including name, department classification, on-line period, contact data, etc.;

(e) identifying 45, after identified, the employee data being stored in the database;

(f) if insertion, edition or deletion of employee data is completed 46, if not, steps (b) to (f) being repeated; and

(g) insertion, edition or deletion of data of employees of the supplier is completed 47.

The supplier employee data managing system 40 of the present invention includes preset fields for the employee data:

a department classification field;

a registration name field;

a registration password field including field of double check, password reminder, answer, etc.;

a registration period field including on-line date and off-line date;

an employee data field including field of Chinese and English names, identification number, employee serial number, etc.;

a contact telephone field including field of telephone number, extension number, facsimile number, cellular phone number, etc.; and

an employee basic data field including field of identification number, residence address, education degree, past career, interest, hobby, etc.

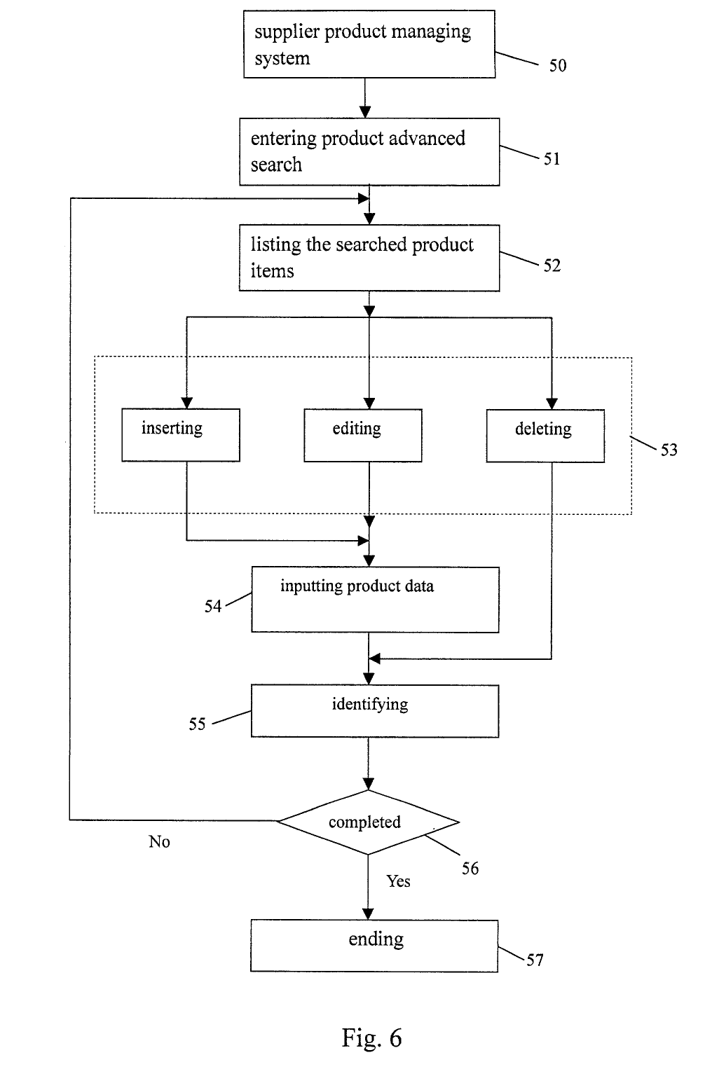

FIG. 6 is a flow chart of management of supplier product data according to the present invention. The execution steps of the supplier product managing system 50 include:

(a) entering product advanced search 51, the searched items including product name, product code, product classification, etc. or the figure of product being directly clicked;

(b) listing the searched product items 52;

(c) inserting, editing or deleting a product item 53, in case of deletion, jumping to step (e), otherwise, next step being executed;

(d) inputting product data 54, including product name, product classification, product figure, etc.;

(e) identifying 55, after identified, the product data being stored in the database;

(f) if insertion, edition or deletion of product data is completed 56, if not, steps (b) to (f) being repeated; and

(g) insertion, edition or deletion of product data of the supplier is completed 57.

The supplier product data managing system 50 of the present invention includes preset fields for the product data:

a product name field;

a manufacturer name field;

a model name field;

a product description field;

a code bar field;

a product figure field;

a product scale figure field;

a trade type field;

a trade monetary kind field;

a unit price field;

a suggested price field;

a product unit kind field;

a product number field;

a file establishing date field; and

a note field.

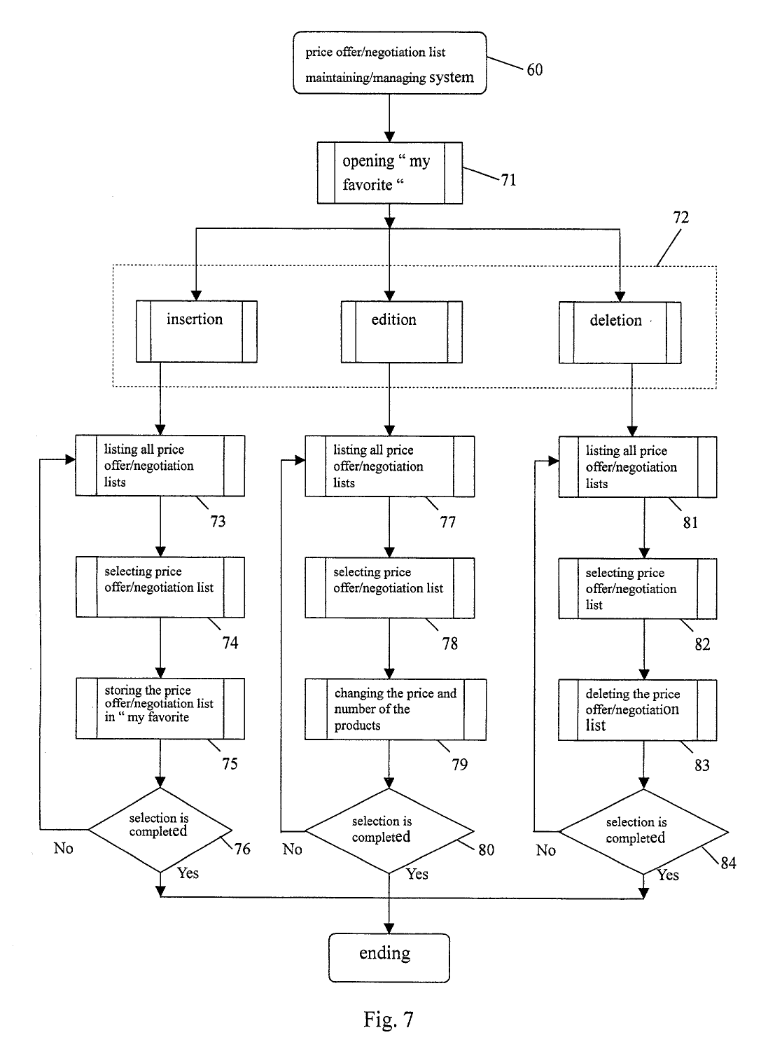

FIG. 7 is a structural block diagram of the price offer/negotiation list maintaining/managing system 60 of the present invention. The price offer/negotiation list maintaining/managing system 60 enables a supplier to manage the price offer/negotiation list records between the supplier and the enterprise owner. There may be numerous data in the price offer/negotiation list records due to a plurality of suppliers and times of trade. It will cost the supplier very much time in case each time the supplier gains access to the enterprise web site 2 for trade, the supplier must search the past or current price offer/negotiation list records. The present invention enables the supplier to store the price offer/negotiation list in proceeding or store the price offer/negotiation list of certain specific trade (such as urgent case). Accordingly, the supplier can according to the record make further trade or renegotiate the price. The present invention permits all suppliers to use personal “my favorite” to manage the price offer/negotiation list records. The execution steps of the price offer/negotiation list maintaining/managing system 60 include:

(a) opening “my favorite” 71;

(b) selecting insertion, edition or deletion of the price offer/negotiation list records in the “my favorite” 72, in case of insertion, step (c) being executed, in case of edition, step (g) being executed, in case of deletion, step (k) being executed;

(c) listing all price offer/negotiation lists in the database 73;

(d) selecting price offer/negotiation list needing to insert 74;

(e) storing the price offer/negotiation list in “my favorite” 75;

(f) if selection is completed 76, if not, steps (c) to (f) being repeated, if so, “my favorite” being stored into the database of the servo main frame 1 to complete the insertion;

(g) listing all price offer/negotiation lists in my favorite 77;

(h) selecting price offer/negotiation list needing to edit 78;

(i) changing the price and number of the products listed in the price offer/negotiation list 79;

(j) if selection is completed 80, if not, steps (g) to (j) being repeated, if so, “my favorite” being stored into the database of the servo main frame 1 to complete the edition;

(k) listing all price offer/negotiation lists in “my favorite” 81;

(l) selecting price offer/negotiation list needing to delete 82;

(m) deleting the price offer/negotiation list 83; and

(n) if selection is completed 84, if not, steps (k) to (n) being repeated, if so, “my favorite” being stored into the database of the servo main frame 1 to complete the deletion.

The on-line purchase supplier web site managing system of the present invention is characterized by:

1. The present invention enables an enterprise owner to easily manage data of suppliers so as to lower cost, save personnel fee and promote management efficiency.

2. The present invention can build private purchase web site of the enterprise to have an advantageous position in electronic business and also simplify the procedure of purchase.

3. The present invention by way of web site combines internal resource of the enterprise with the resource of upstream suppliers to achieve the object of management of purchase, sale and storage.

The above embodiment is only used to illustrate the present invention, not intended to limit the scope thereof. Many modifications of the above embodiment can be made without departing from the spirit of the present invention.

What is claimed is:

1. On-line purchase supplier web site managing system, an enterprise web site being built in a servo main frame, the enterprise web site enabling an enterprise owner to through internet make purchase trade with one or more than one supplier, the enterprise web site mainly includes a supplier web site managing system by which suppliers set up basic data of their companies and their products on the enterprise web site, by means of the set up data, the enterprise owner being able to go for purchase trade, the supplier web site managing system including:
a supplier data managing system mainly serving to set up and maintain basic data of the suppliers' companies;
a supplier department managing system mainly serving to set up and maintain the department data of the suppliers;
a supplier employee managing system mainly serving to set up and maintain the employee data of the suppliers;
a supplier product managing system mainly serving to set up and maintain the data of the products sold by the suppliers; and
a price offer/negotiation list maintaining/managing system mainly serving to maintain and manage the price offer/negotiation lists of the suppliers to the enterprise owner.

2. On-line purchase supplier web site managing system as claimed in claim 1, wherein the supplier data managing system enables the suppliers gaining access to the enterprise web site to insert, edit and delete company basic data in preset field, the execution steps of the supplier data managing system including:
(a) displaying basic data of the supplier in the database;
(b) inserting, editing or deleting basic data of the supplier, in case of editing, jumping to step (d), in case of deletion of field, jumping to step (e);
(c) automatically giving a supplier code;
(d) inputting basic data of the supplier;
(e) identifying;
(f) if insertion, edition or deletion is completed, if not, steps (a) to (f) being repeated; and
(g) insertion, edition or deletion of basic data of the supplier is completed.

3. On-line purchase supplier web site managing system as claimed in claim 2, wherein in step (d), the supplier data managing system includes preset fields for the supplier's basic data:
a company name field including field of Chinese and English names and abbreviations or short names, etc.;
a company address field including field of country, state/province, city, zip code and detailed address, etc.;
a telephone/facsimile field including field of telephone number, cellular phone number and facsimile number, etc.;
a company web address field;
a company data field including field of capital, number of employees, classification of business, etc.;
a president field including field of name, extension number, E-mail box, etc. of the president;
a company contact man field including field of name, position, extension number, E-mail box, etc. of the contact man;
an invoice data field including field of invoice classification, invoice title, invoice address, etc.;
a shipping manner field including field of shipping condition, shipping description and delivery date, etc.;
a trade manner field including field of trade manner, trade condition description, trade monetary kind, pay way, pay condition description, pay date, tax rate, etc.;
a registration date field;
a use period field including on-line date and off-line date; and
a bank data field including field of bank name, account classification, account name, account number, bank address, telephone and facsimile numbers of bank contact man, etc.

4. On-line purchase supplier web site managing system as claimed in claim 1, wherein the supplier department managing system enables the suppliers to use the enterprise web site to manage the department data of their own companies, the execution steps of the supplier department managing system including:
(a) inputting code and password of the supplier;
(b) displaying department data of the supplier;
(c) inserting, editing or deleting a department, in case of deletion, jumping to step (e), otherwise, next step being executed;
(d) inputting department data;
(e) identifying;
(f) if insertion, edition or deletion of department data is completed, if not, steps (b) to (f) being repeated; and
(g) insertion, edition or deletion of department data of the supplier is completed.

5. On-line purchase supplier web site managing system as claimed in claim 1, wherein the supplier employee managing system enables the suppliers to manage data of those employees who can gain access to the enterprise web site for trade, the execution steps of the supplier employee managing system including:
(a) inputting code and password of the supplier;
(b) displaying employee data of the supplier;
(c) inserting, editing or deleting employee data, in case of deletion, jumping to step (e), otherwise, next step being executed;
(d) inputting employee data;
(e) identifying;
(f) if insertion, edition or deletion of employee data is completed, if not, steps (b) to (f) being repeated; and
(g) insertion, edition or deletion of data of employees of the supplier is completed.

6. On-line purchase supplier web site managing system as claimed in claim 5, wherein in step (d), the supplier employee data managing system includes preset fields for the employee data:
a department classification field;
a registration name field;
a registration password field including field of double check, password reminder, answer, etc.;
a registration period field including on-line date and off-line date;
an employee data field including field of Chinese and English names, identification number, employee serial number, etc.;
a contact telephone field including field of telephone number, extension number, facsimile number, cellular phone number, etc.; and
an employee basic data field including field of identification number, residence address, education degree, past career, interest, hobby, etc.

7. On-line purchase supplier web site managing system as claimed in claim 1, wherein the execution steps of the supplier product managing system include:
(a) entering product advanced search, the searched items including product name, product code, product classification, etc. or the figure of product being directly clicked;
(b) listing the searched product items;
(c) inserting, editing or deleting a product item, in case of deletion, jumping to step (e), otherwise, next step being executed;
(d) inputting product data;
(e) identifying;
(f) if insertion, edition or deletion of product data is completed, if not, steps (b) to (f being repeated; and
(g) insertion, edition or deletion of product data of the supplier is completed.

8. On-line purchase supplier web site managing system as claimed in claim 7, wherein in step (d), the supplier product data managing system includes preset fields for the product data:
a product name field;
a manufacturer name field;
a model name field;
a product description field;
a code bar field;
a product figure field;
a product scale figure field;
a trade type field;
a trade monetary kind field;
a unit price field;
a suggested price field;
a product unit kind field;
a product number field;
a file establishing date field; and
a note field.

9. On-line purchase supplier web site managing system as claimed in claim 1, wherein the price offer/negotiation list maintaining/managing system enables all the suppliers to use personal “my favorite” to manage the price offer/negotiation list records, the execution steps of the price offer/negotiation list maintaining/managing system including:
(a) opening “my favorite”;
(b) selecting insertion, edition or deletion of the price offer/negotiation list records in the “my favorite”, in case of insertion, step (c) being executed, in case of edition, step (g) being executed, in case of deletion, step (k) being executed;
(c) listing all price offer/negotiation lists;
(d) selecting price offer/negotiation list needing to insert;
(e) storing the price offer/negotiation list in “my favorite”;
(f) if selection is completed, if not, steps (c) to (f) being repeated, if so, “my favorite” being stored to complete the insertion;
(g) listing all price offer/negotiation lists in “my favorite”;
(h) selecting price offer/negotiation list needing to edit;
(i) changing the price and number of the products listed in the price offer/negotiation list;
(j) if selection is completed, if not, steps (g) to (j) being repeated, if so, “my favorite” being stored to complete the edition;
(k) listing all price offer/negotiation lists in “my favorite”;
(l) selecting price offer/negotiation list needing to delete;
(m) deleting the price offer/negotiation list; and
(n) if selection is completed, if not, steps (k) to (n) being repeated, if so, “my favorite” being stored to complete the deletion.
